(19) United States
(12) Patent Application Publication
(10) Pub. No.: US 2011/0043543 A1
(43) Pub. Date: Feb. 24, 2011

(54) COLOR TUNING FOR ELECTROPHORETIC DISPLAY

(76) Inventors: Hui Chen, Santa Clara, CA (US); HongMei Zang, Sunnyvale, CA (US); Robert A. Sprague, Saratoga, CA (US)

Correspondence Address: HOWREY LLP (07783), C/O IP DOCKETING DEPARTMENT, 1299 Pennsylvania Avenue, NW, Room B-3, Washington, DC, 20004-2402, US

(21) Appl. No.: 12/852,411

(22) Filed: Aug. 6, 2010

Related U.S. Application Data
(60) Provisional application No. 61/234,959, filed on Aug. 18, 2009.

(51) Int. Cl. G09G 5/10; G09G 3/34

(52) U.S. Cl. 345/690; 345/107

(57) ABSTRACT

The present invention is directed to a color tuning composition and a method for adjusting the color temperature of an electrophoretic display. A display device comprising a color tuning layer of the present invention has several advantages. For example, the colors of the images displayed may be modified according to different needs without affecting the performance of the display device; the level of whiteness may be improved; and in some cases, the need for a UV barrier layer may also be eliminated.

This application claims priority to U.S. Provisional Application No. 61/234,959, filed Aug. 18, 2009; the content of which is incorporated herein by reference in its entirety.

### FIELD OF THE INVENTION

The present invention is directed to a color tuning composition and a method for adjusting color temperature of an electrophoretic display.

### BACKGROUND OF THE INVENTION

An electrophoretic display (EPD) is a non-emissive bi-stable output device which utilizes the electrophoresis phenomenon of charged pigment particles suspended in a dielectric solvent, to display images. An electrophoretic display usually comprises two plates with electrodes placed opposing each other. One of the electrodes is typically transparent. An electrophoretic fluid comprising charged pigment particles dispersed in a dielectric solvent or solvent mixture is enclosed between the two plates. When a voltage potential is applied to the two electrodes, the charged pigment particles migrate toward the electrode having an opposite polarity from the pigment particles, thus displaying either the color of the charged pigment particles or the color of the dielectric solvent or solvent mixture. Alternatively, if the electrodes are applied the same polarity, the charged pigment particles may then migrate to the one having a higher or lower voltage potential, depending on the polarity of the charged pigment particles. Further alternatively, the electrophoretic fluid may comprise a clear fluid with two types of pigment particles dispersed therein; the two types of pigment particles migrate to opposite sides of the display device when a voltage potential is applied.

The electrophoretic display exhibits colors by either reflecting (white state) or absorbing (dark state) the visible lights. In general, the components in the electrophoretic fluid need to be optimized in order to achieve an acceptable level of whiteness (i.e., brightness) and contrast ratio of the images displayed. The whiteness and contrast ratio are critical factors that determine the quality of a display device.

### SUMMARY OF THE INVENTION

The present inventors have found an effective approach to adjust and enhance the color temperature and improve apparent whiteness and color neutrality of an electrophoretic display, without sacrificing the performance of the display device.

The first aspect of the invention is directed to a display device which comprises
a) display cells filled with a display fluid; and
b) a color tuning layer formed from a color tuning composition comprising a colorant and a polymer carrier.

In one embodiment, the display fluid comprises charged pigment particles dispersed in a dielectric solvent or solvent mixture. In one embodiment, the colorant is a light absorbing or light emitting material. In one embodiment, the light absorbing material is an organic and inorganic dye or pigment. In one embodiment, the light emitting material is a photoluminescent material. In one embodiment, the photoluminescent material is a fluorescent dye or fluorescent inorganic phosphor. In one embodiment, the colorant is a fluorescent brightening agent. In one embodiment, the fluorescent brightening agent is triazine-stilbene (di-, tetra- or hexa-sulfonated), coumarin, imidazoline, diazole, triazole, benzoxazoline or biphenyl-stilbene. In one embodiment, the polymer carrier is a thermoplastic material, a thermoset material or a precursor or derivatives thereof. In one embodiment, the color tuning layer is on a substrate layer of an electrode layer or a functional layer, whereby one side of the substrate layer is the color tuning layer and the other side of the substrate layer is the electrode layer or the functional layer. In one embodiment, the display device further comprises a luminance enhancement structure.

The second aspect of the invention is directed to a display device which comprises
a) display cells filled with a display fluid; and
b) a functional layer formed from a composition comprising a colorant.

In one embodiment on the second aspect of the invention, the display fluid comprises charged pigment particles dispersed in a dielectric solvent or solvent mixture. In one embodiment, the colorant is a light absorbing or light emitting material. In one embodiment, the light absorbing material is an organic and inorganic dye or pigment. In one embodiment, the light emitting material is a photoluminescent material. In one embodiment, the photoluminescent material is a fluorescent dye or fluorescent inorganic phosphor. In one embodiment, the colorant is a fluorescent brightening agent. In one embodiment, the fluorescent brightening agent is triazine-stilbene (di-, tetra- or hexa-sulfonated), coumarin, imidazoline, diazole, triazole, benzoxazoline or biphenyl-stilbene. In one embodiment, the functional layer is an adhesive layer and the composition further comprises an adhesive. In one embodiment, the functional layer is an antiglare coating, hard coating or luminance enhancement structure.

The third aspect of the invention is directed to a method for tuning the colors of a display device, which method comprises
i) determining color temperature of the display;
ii) selecting one or more colorant based on the color temperature; and
iii) forming a color tuning composition comprising said colorant and a polymer carrier and applying the color tuning composition to a substrate layer or incorporating said colorant into a composition for a component in the display.

In one embodiment of the third aspect of the invention, the colorant is a light absorbing or light emitting material. In one embodiment, the light absorbing material is an organic and inorganic dye or pigment. In one embodiment, the light emitting material is a photoluminescent material. In one embodiment, the photoluminescent material is a fluorescent dye or fluorescent inorganic phosphor. In one embodiment, the colorant is a fluorescent brightening agent. In one embodiment, the display device is an electrophoretic display.

One of the challenges in achieving a good black and white display is to balance the colors of the dispersion components to obtain a “neutral” color which is more pleasing to the eye. The current invention proposes a solution to achieve that. A display device comprising a color tuning layer of the present invention has several advantages. For example, the colors of the images displayed may be modified according to different needs without affecting the performance of the display device; the level of whiteness may be improved; and in some cases, the need for a UV barrier layer may also be eliminated if the absorption in the ultraviolet range of the color tuning layer is sufficient to block all of the UV energy.

### BRIEF DISCUSSION OF THE DRAWINGS

FIG. 1 depicts the cross-section view of an electrophoretic display.

FIGS. 2a-2b illustrate how a color tuning layer of the present invention is implemented.

### DETAILED DESCRIPTION OF THE INVENTION

### Display Devices

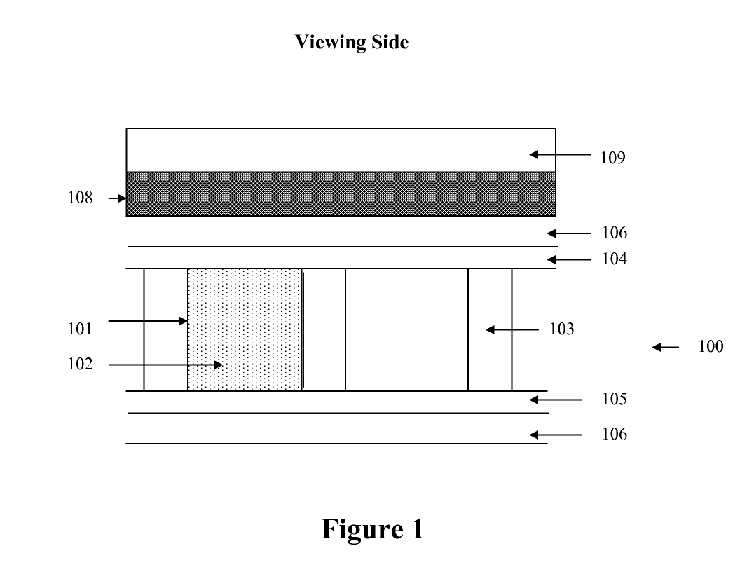

FIG. 1 illustrates an electrophoretic display device (100). The device comprises a plurality of display cells (101) which are filled with an electrophoretic fluid (102) and sandwiched between two electrode layers (104 and 105). Each of the display cells is surrounded by partition walls (103). The electrophoretic fluid may be a system comprising one or two types of pigment particles.

In the system comprising only one type of particles, the charged pigment particles are dispersed in a solvent of a contrasting color. The charged particles will be drawn to one of the electrode layers (104 or 105), depending on the potential difference of the two electrode layers, thus causing the display panel to show either the color of the particles or the color of the solvent, on the viewing side. In a system comprising particles carrying opposite charges and having two contrasting colors, the particles would move to one electrode layer or the other, based on the charge that they carry and the potential difference of the two electrode layers, causing the display panel to show the two contrasting colors, on the viewing side. In this case, the particles may be dispersed in a clear and colorless solvent.

For a segmented display device, the two electrode layers (104 and 105) are one common electrode (e.g., ITO) and one patterned segment electrode layer, respectively. For an active matrix display device, the two electrode layers (104 and 105) are one common electrode and an array of thin film transistor pixel electrodes, respectively. For a passive matrix display device, the two electrode layers (104 and 105) are two line-patterned electrode layers.

The patterned segment electrode layer (in a segment display device), the thin film transistor pixel electrodes (in an active matrix display device) or one of the line-patterned electrode layers (in a passive matrix display device) may be referred to as a “backplane”, which along with the common electrode drives the display device.

The electrode layers are usually formed on a substrate layer (106) such as polyethylene terephthalate (PET). The substrate layer may also be a glass layer.

For a microcup-based display device disclosed in U.S. Pat. No. 6,930,818, the content of which is incorporated herein by reference in its entirety, the filled display cells are sealed with a polymeric sealing layer. Such a display device may be viewed from the sealing layer side or the side opposite the sealing layer side, depending on the transparency of the materials used and the application.

An electrophoretic display may optionally comprise a luminance enhancement structure (108) on the viewing side of the display device. The purpose of a luminance enhancement structure is to increase the brightness of the displayed images. An example of a luminance enhancement structure suitable for the present invention comprises grooves and columns wherein each of said grooves has a cross-section comprising an apex angle and two edge lines. The luminance enhancement structure may have a one dimensional configuration or a two dimensional configuration. Additional details of luminance enhancement structures are found in U.S. Ser. No. 12/323,300 filed on Nov. 25, 2008, U.S. Ser. No. 12/323,315 filed on Nov. 25, 2008, US2009-0231245, US2010-0141573, US2010-0177396, US2010-0182351, and U.S. Ser. No. 12/719,702 filed on Mar. 8, 2010, the contents of all of which are incorporated herein by reference in their entirety.

An electrophoretic display may further optionally comprise one or more auxiliary (or functional) layers (109), such as UV protective layer, oxygen/moisture barrier layer, antiglare layer, touch panel or optical transparent adhesives.

The luminance enhancement structure and the auxiliary layers are usually formed on a substrate layer and then laminated to the display with an adhesive. For brevity, the substrate and adhesive layers are not shown in FIG. 1.

While an electrophoretic display is specifically mentioned in this application, it is understood that the present technology may be applied to any type of reflective display devices, such as electrophoretic and liquid crystal displays.

The term “color tuning”, in the context of the present invention, is referred to a layer or a composition which has the ability to adjust the color temperature of a display device.

The term “color temperature”, which is often used in art or photography, is a characteristic of visible light. The color temperature of a light source is determined by comparing its chromaticity with that of an ideal black-body radiator. The temperature, usually measured in kelvins (K), at which the heated black-body radiator matches the color of the light source is that source's color temperature. Higher color temperatures (5000 K or more) are “cool” (green-blue) colors, and lower color temperatures (2700-3000 K) are “warm” (yellow-red) colors.

A color tuning composition of the present invention may comprise a polymer carrier and a colorant (i.e., a color generating material). The colorant, in the context of the present invention, may be a light absorbing or light emitting material. Light absorbing colorants may include, but are not limited to, organic and inorganic dyes and pigments. Light emitting colorants may include, but are not limited to, photoluminescent materials, such as fluorescent dyes, fluorescent inorganic phosphors or the like. In one embodiment, a fluorescent brightening agent may be used as a colorant. Suitable fluorescent brightening agents may include, but are not limited to, triazine-stilbenes (di-, tetra- or hexa-sulfonated), coumarins, imidazolines, diazoles, triazoles, benzoxazolines, biphenyl-stilbenes and the like. Examples of commercially available colorants for the purpose of the present invention may include, but are not limited to, Tinopal OB (by Ciba), Eastobrite OB-1 (by Eastman), Eastobrite OB-3 (by Eastman), Hostalux KCB (by Clariant), Hostalux KSN (by Clariant), Uvitex FP (by Ciba), D-298 (by DayGlo), D-286 (by DayGlo), D-282 (by DayGlo) and D-211 (by DayGlo). Since the fluorescent materials all have strong absorption in the UV range, the color tuning layer made from the materials may also help block harmful UV rays and protect the display film.

The polymer carrier is used to hold the colorant in a solid form. Suitable polymer carriers may include, but are not limited to, thermoplastic materials, thermoset materials, or precursors and derivatives thereof, such as polyvinyl acetate, polyacrylate, polyurethane, polyvinyl butyral, polyvinyl chloride, polyester, polyacrylic or any other UV curable materials.

Solvents are used to dissolve or disperse the polymer carrier and colorant to form the color tuning composition. The composition in a liquid form may then be coated onto a substrate layer, using traditional coating methods. The solvent used is usually an organic solvent, such as one selected from the group consisting of ketones, alcohols, tetrahydrofuran, toluene, xylene, dimethylformamide, diethylene glycol, dimethyl sulfoxide, acetonitrile hexane, cyclohexane and the like. An aqueous solvent may also be used.

It is preferred that the weight percentage of the polymer carrier in the composition is less than about 60%, more preferably about 5% to about 30%, and the colorant weight percentage is preferably less than about 3%, more preferably about 0.1% to about 1%. The remaining is solvent and additives.

For most of organic dyes or organic fluorescent materials, the composition can be prepared by simply dissolving all the solid components in a solvent or a mixture of solvents and mixing well with proper agitation. If pigments or phosphors are used, dispersing tools, such as a milling machine, homogenizer or sonicator, are required to disperse the solid materials into the liquid polymer solution. Commonly used dispersing agents, such as BYK163, may be added to facilitate the dispersion of pigments or phosphors.

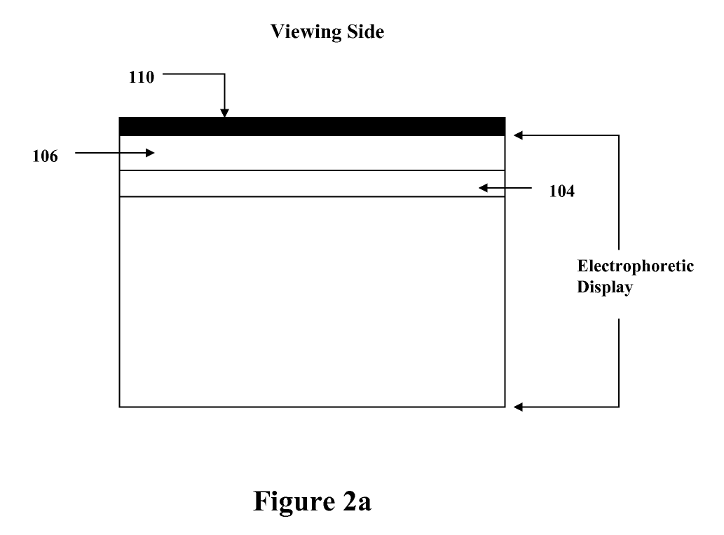

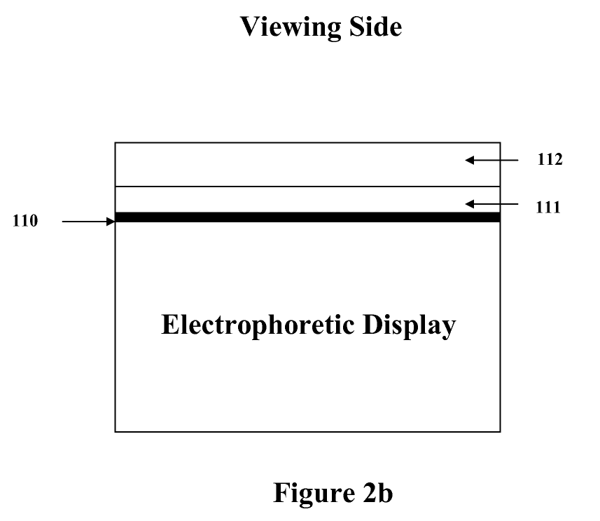

The color tuning composition as described above may be in the form of a separate layer. As shown in FIG. 2a, the color tuning composition (110) is coated on the substrate layer (106) opposite of the electrode layer (104).

The color tuning composition may also be coated on a substrate layer of a functional layer in a display device. In this embodiment, one side of the substrate layer is a color tuning layer whereas the other side of substrate layer is the functional layer. In FIG. 2b, a color tuning layer (110) is laminated onto a substrate layer (111) on the opposite side of a functional layer (112). The functional layer may be an antiglare film, a luminance enhancement structure or a gas barrier layer.

After a color tuning composition is applied to a substrate layer, the composition may be hardened by drying, radiation or both.

Alternatively, the colorant in the color tuning composition may be directly incorporated into a component layer in the display device. For example, the colorant may be dispersed in a composition for forming an adhesive layer, antiglare coating or hard coating.

In the case of an adhesive layer, the adhesive material itself can be a liquid or solid adhesive, such as rubber, styrene butadiene copolymer, acrylonitrile butadiene, polyisobutylene, silicone elastomer, polyvinyl acetal, polyvinyl acetate, polyvinyl alcohol, ethylene vinyl acetate copolymer, cellulosic resin, polyamide, polyester, polyurethane, polyolefins, polysulfone, phenoxy, acrylic, a UV curable material or the like.

In the case of hard coating or antiglare coating, a colorant may be added to a thermoset polymer that can be thermally or UV cured. Suitable thermoset polymers include, but are not limited to, acrylate, polyurethane-acrylate, epoxy-acrylate, epoxy, organic silicone and two component polyurethane.

Further alternatively, the colorant may be embedded in a composition for forming a plastic substrate or in a composition for forming a luminance enhancement structure, to achieve the same desired results.

The composition for forming a luminance enhancement structure is disclosed in the US patent applications referred to above.

For plastic substrates, the colorants need to be mixed with the plastic polymer component before extrusion of the plastic film or the colorants can be added in at a high temperature. When the colorants are added into a composition, such as luminance enhancement structure or a functional layer, the colorants are dissolved or dispersed in the composition.

Another aspect of the present invention is directed to a method for adjusting the color temperature of an electrophoretic display.

In the present method, the color spectra of an electrophoretic display are first obtained. A UV-vis spectrometer can be used to obtain the absorption spectra of liquid particle dispersion or the absorption spectra of functional layers; while colorimeters can be used to determine the reflectance of a display.

In addition to the spectra, a CIE L, a, b color space system may also be used to determine the color temperature of the display. The details of the CIE L,a,b color space system are given in “Understanding Color Management” by Abhay Sharma (Delmar Cengage Learning; First Edition, Aug. 11, 2003), the content of which is incorporated herein by reference in its entirety.

Following the method of the present invention, the “a” value in the CIE L,a,b color space system may be achieved between 3 and minus 6 (i.e., −6), preferably between 0 and minus 3 (i.e., −3), more preferably between 0 and minus 1.5 (i.e.,−1.5) and the “b” value may be achieved between 4 and minus 5 (i.e., −5), preferably between 1 and minus 2 (i.e., −2), more preferably between 0 and minus 2 (i.e., −2).

Based on the spectra obtained, a colorant is then selected to adjust the color temperature, if needed.

In summary, the method for tuning the colors of a display device comprises
a) determining color temperature of the display;
b) selecting one or more colorant based on the color temperature; and
c) forming a color tuning composition comprising said colorant and a polymer carrier and applying the color tuning composition to a substrate layer or incorporating said colorant into a composition for a component in the display.

In one embodiment, the substrate layer may be on an electrode layer or a functional layer.

In another embodiment, the component may be an adhesive layer, a substrate layer, a luminance enhancement structure or a functional layer.

### EXAMPLES

### Example 1

### Color Tuning Layer as a Separate Coating

TABLE 1

| | | | % By Weight |
|---|---|---|---|
| Component | Chemical Name | % By Weight | in Dry Form |
| Polyacrylate | — | 32.42 | 99 |
| Resin | | | |
| Tinopal OB | 2,5-Thio | 0.16 | 0.5 |
| | phenediyl-bis(5- | | |
| | tert-butyl-1,3- | | |
| | benzoxazole) | | |
| UV Stabilizer 292 | Bis(1,2,2,6,6- | 0.16 | 0.5 |
| | pentamethyl-4- | | |
| | piperidinyl) | | |
| | sebacate | | |
| Tetrahydrofuran | — | 67.26 | — |

Tinopal OB and UV stabilizer 292 were first dissolved in tetrahydrofuran and then the polyacrylate resin was added in the solution with agitation. The mixture was kept under stirring until the polymer binder was completely dissolved. The resulting solution was coated on a PET plastic film surface with a wire wound coating rod (#6) and dried in an oven for 1 minute at 100° C. The resulting film had a thickness of about 5 μm. This layer emitted blue visible light when exposed to UV light with wavelength around 370 nm. The color tuning layer was laminated to an electrophoretic display film.

In Table 2 below, colors are expressed as the “a” and “b” values in the CIE L,a,b color space system. It is clear from the table that “b” value had been tuned from 1.14 to −1.59 when a color tuning layer was present. If a thicker coating is used (˜20 μm), the reflectance of EPD film would also be increased by about 2%.

TABLE 2

| | Without Color | With Color |
|---|---|---|
| | Tuning Layer | Tuning Layer |
| “a” | −2.43 | −1.92 |
| “b” | +1.14 | −1.59 |

### Example 2

### Color Tuning Material Incorporated into an Adhesive

TABLE 3

| | | % By Weight |
|---|---|---|
| Component | % By Weight | in Dry Form |
| Thermoplastic Polyurethane | 11.3 | 99.8 |
| Pigment Red | 0.023 | 0.2 |
| Methylethyl Ketone (MEK) | 88.677 | — |

Pigment particles were first dispersed in MEK with a mill roller for 24 hours and then homogenized for 10 minutes. The polyurethane resins were then added into the solution and stirred until they were completely dissolved. The mixture was coated onto a release liner with a drawdown bar at a thickness of 3 mil and then dried in an oven at 100° C. for 2 minutes. A luminance enhancement structure was laminated onto an EPD film with the resulting adhesive composition through the use of a laminator at 120° C. and 80 psi. The adhesive layer showed a shift of the “a” value in the CIE L, a, b color space system to the positive direction by 1 unit and neutralized the green cast

While the present invention has been described with reference to the specific embodiments thereof, it should be understood by those skilled in the art that various changes may be made and equivalents may be substituted without departing from the scope of the invention. In addition, many modifications may be made to adapt a particular situation, materials, compositions, processes, process step or steps, to the objective, spirit and scope of the present invention. All such modifications are intended to be within the scope of the claims appended hereto.

What is claimed is:

1. A display device comprising:
a) display cells filled with a display fluid; and
b) a color tuning layer formed from a color tuning composition comprising a colorant and a polymer carrier.

2. The display device of claim 1, wherein said colorant is a light absorbing or light emitting material.

3. The display device of claim 2, wherein said light absorbing or light emitting material is an organic and inorganic dye or pigment or a photoluminescent material.

4. The display device of claim 3, wherein said photoluminescent material is a fluorescent dye or fluorescent inorganic phosphor.

5. The display device of claim 1, wherein said colorant is a fluorescent brightening agent.

6. The display device of claim 5, wherein said fluorescent brightening agent is triazine-stilbene (di-, tetra- or hexa-sulfonated), coumarin, imidazoline, diazole, triazole, benzoxazoline or biphenyl-stilbene.

7. The display device of claim 1, wherein said polymer carrier is a thermoplastic material, a thermoset material or a precursor or derivatives thereof.

8. The display device of claim 1, wherein said color tuning layer is on a substrate layer adhered to an electrode layer or a functional layer, whereby one side of the substrate layer is the color tuning layer and the other side of the substrate layer is the electrode layer or the functional layer.

9. A display device comprising:
a) display cells filled with a display fluid; and
b) a functional layer formed from a color tuning composition comprising a colorant.

10. The display device of claim 9, wherein said colorant is a light absorbing or light emitting material.

11. The display device of claim 10, wherein said light absorbing or light emitting material is an organic and inorganic dye or pigment or a photoluminescent material.

12. The display device of claim 11, wherein said photoluminescent material is a fluorescent dye or fluorescent inorganic phosphor.

13. The display device of claim 9, wherein said colorant is a fluorescent brightening agent.

14. The display device of claim 13, wherein said fluorescent brightening agent is triazine-stilbene (di-, tetra- or hexa-sulfonated), coumarin, imidazoline, diazole, triazole, benzoxazoline or biphenyl-stilbene.

15. The display device of claim 9, wherein said functional layer is an adhesive layer, an antiglare coating, hard coating or luminance enhancement structure.

16. The display device of claim 1, further comprising a luminance enhancement structure.

17. A method for tuning the colors of a display device, which method comprising:
i) determining color temperature of the display;
ii) selecting one or more colorant based on the color temperature; and
iii) forming a color tuning composition comprising said colorant and a polymer carrier and applying the color tuning composition to a substrate layer or incorporating said colorant into a composition for a component in the display.

18. The method of claim 17, wherein said colorant is a light absorbing or light emitting material.

19. The method of claim 17, wherein said display device is an electrophoretic display.

20. The method of claim 17, which achieves an “a” value in the CIE L,a,b color space system between 3 and minus 6 and a “b” value between 4 and minus 5.

21. The method of claim 17, which achieves an “a” value in the CIE L,a,b color space system between 0 and minus 3 and a “b” value between 1 and minus 2.

22. The method of claim 17, which achieves an “a” value in the CIE L,a,b color space system between 0 and minus 1.5 and a “b” value between 0 and minus 2.
